(19) United States
(12) Patent Application Publication
(10) Pub. No.: US 2014/0351074 A1
(43) Pub. Date: Nov. 27, 2014

(54) SYSTEM AND METHOD FOR MANAGING AUCTION DATA

(71) Applicant: Manheim Investments, Inc., Atlanta, GA (US)

(72) Inventors: Trevor Enge, Atlanta, GA (US); Amy Mills, Atlanta, GA (US); Mark Franklin, Atlanta, GA (US); Chad Sexton, Atlanta, GA (US); Paul Holder, Atlanta, GA (US); Patrick Boggs, Atlanta, GA (US); Michael Baker, Atlanta, GA (US); Laura Hunnicutt, Atlanta, GA (US); Woodson Savage, Atlanta, GA (US)

(73) Assignee: Manheim Investments, Inc., Atlanta, GA (US)

(21) Appl. No.: 14/285,375

(22) Filed: May 22, 2014

Related U.S. Application Data
(60) Provisional application No. 61/826,106, filed on May 22, 2013.

(51) Int. Cl. G06Q 30/08

(52) U.S. Cl. CPC G06Q 30/08
USPC 705/26.3

(57) ABSTRACT

The present disclosure relates to computer-implemented systems and methods for searching auction data. According to one or more embodiments of the disclosure, a method is provided. The method may include accessing auction data associated with a plurality of auction lanes in a vehicle auction. The method may also include determining, based at least in part on the auction data, one or more vehicles being auctioned at one or more of the plurality of auction lanes. Additionally, the method may include displaying respective graphical views associated with a subset of the one or more vehicles. Furthermore, the method may include ordering the respective graphical views based at least in part on respective auction times and respective remaining auction times for the subset of the one or more vehicles.

### CROSS-REFERENCE TO RELATED APPLICATION

This application claims the priority benefit of U.S. Provisional Application No. 61/826,106, entitled “System and Method for Managing Auction Data,” filed May 22, 2013.

### TECHNICAL FIELD

The present disclosure generally relates to auctions, and in particular, to managing auction data.

### BACKGROUND

Dealers frequently participate in vehicle auctions to purchase vehicles they feel they will be able to sell at a profit. With the advent of online vehicle auctions, dealers may want to participate in multiple auctions and/or auction lanes simultaneously to fill their inventory needs. Thus, dealers may desire tools that facilitate relatively quick research of vehicles being auctioned at various auctions in order to make an informed decision regarding a potential purchase of one of the vehicles.

### BRIEF DESCRIPTION OF THE DRAWINGS

Reference will now be made to the accompanying figures and diagrams, which are not necessarily drawn to scale, and wherein:

FIG. 1 shows a system for managing auction data according to one or more example embodiments.

FIG. 2 shows a user interface for managing auction data according to one or more example embodiments.

FIG. 3 shows a flow diagram of a method for managing auction data according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “user device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a portable media player, a personal digital assistant (PDA), a kiosk computer for public use, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include social networking web pages. Another example of a server may be a cloud server that hosts web services for one or more computer devices.

As used herein, unless otherwise specified, the term “web page” may correspond to one or more web pages as part of one or more websites.

The present disclosure relates to computer-implemented systems and methods for providing auction data to users such as vehicle dealers, vehicle retailers, vehicle wholesalers, and/or the like. According to one or more embodiments of the disclosure, a method is provided. The method may include accessing, by a server that includes one or more processors, auction data associated with a plurality of auction lanes in a vehicle auction. Moreover, the method may include determining, based at least in part on the auction data, one or more vehicles being auctioned at one or more of the plurality of auction lanes. The method may also include receiving, by the server from a user device, one or more selections associated with a subset of the one or more vehicles.

Additionally, the method may include displaying, by the server, respective graphical views associated with the subset of the one or more vehicles. Furthermore, the method may include ordering the respective graphical views based at least in part on respective auction times and respective remaining auction times for the subset of the one or more vehicles.

According to one or more embodiments of the disclosure, a device is provided. The device may include at least one processor and at least one memory. The at least one memory may store instructions that cause the at least one processor to access auction data associated with a plurality of auction lanes in a vehicle auction. The device may also include instructions to determine, based at least in part on the auction data, one or more vehicles being auctioned at one or more of the plurality of auction lanes. The device may also include instructions to receive, from a user, one or more selections associated with a subset of the one or more vehicles. Additionally, the device may also include instructions to display respective graphical views associated with the subset of the one or more vehicles. Furthermore, the device may also include instructions to order the respective graphical views based at least in part on respective auction times and respective remaining auction times for the subset of the one or more vehicles.

According to one or more embodiments of the disclosure, a non-transitory computer readable medium is provided. The non-transitory computer-readable medium may have embodied thereon instructions executable by one or more processors. The instructions may cause the one or more processors to access auction data associated with a plurality of auction lanes in a vehicle auction. The instructions may further cause the one or more processors to determine, based at least in part on the auction data, one or more vehicles being auctioned at one or more of the plurality of auction lanes. The instructions may further cause the one or more processors to receive, from a user, one or more selections associated with a subset of the one or more vehicles. Furthermore, the instructions may cause the one or more processors to display respective graphical views associated with the subset of the one or more vehicles. The instructions may further cause the one or more processors to order the respective graphical views based at least in part on respective auction times and respective remaining auction times for the subset of the one or more vehicles.

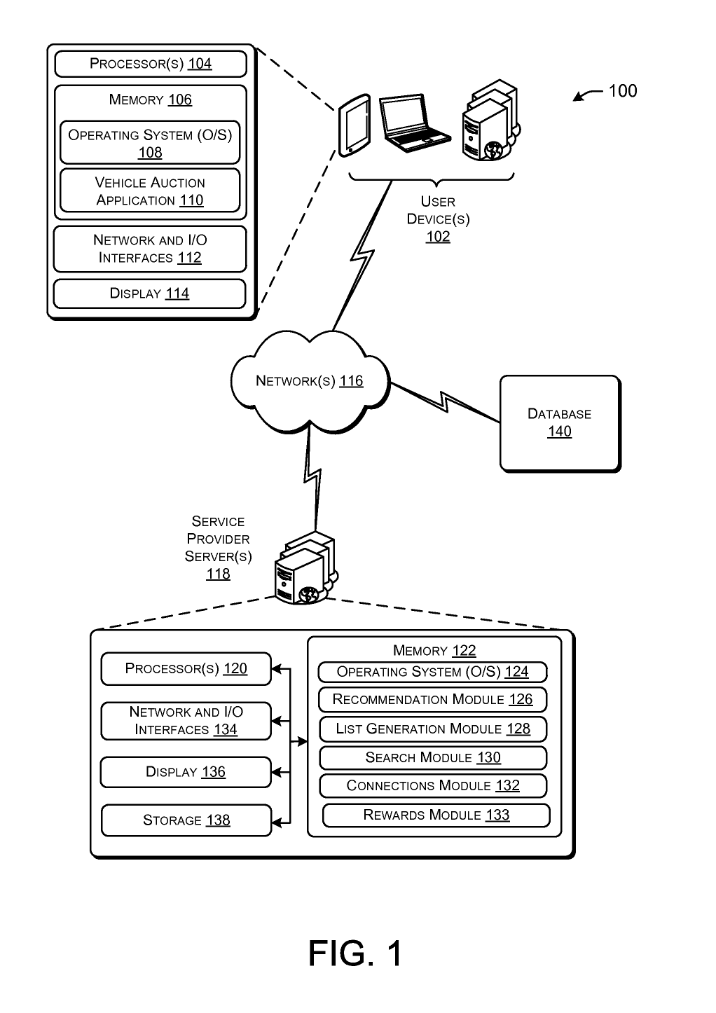

With reference now to FIG. 1, a system 100 for managing auction data is shown according to one or more embodiments of the disclosure. The system 100 may include one or more user device(s) 102. In general, the user device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The user device(s) 102 may include one or more computer processors 104, a memory 108 storing an operating system 108 and a vehicle auction application 110, network and I/O interfaces 112, and a display 114. In certain embodiments, the user device(s) 102 may include one or more sensors capable of gathering information associated with a present environment of the user device(s) 102, or similar hardware devices, such as a camera, microphone, antenna, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 104 and one or more of the other components of the user device 102. In certain embodiments, the user device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may comprise one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the user device 102. The memory 106 may also store content that may be displayed by the user device 102 or transferred to other devices (e.g., headphones) to be displayed or played by the other devices. The memory 106 may also store content received from the other devices. The content from the other devices may be displayed, played, or used by the user device 102 to perform any necessary tasks or operations that may be implemented by the computer processor or other components in the user device 102. Furthermore, the memory 106 may store a vehicle auction application 110 to facilitate managing, searching, purchasing, bidding, or otherwise facilitating transactions for one or more vehicles being auctioned at one or more vehicle auctions, as described in more detail below.

The network and I/O interfaces 112 may also comprise one or more communication interfaces or network interface devices to provide for the transfer of data between the user device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The user device 102 may be coupled to the network via a wired connection. However, the wireless system interfaces may include the hardware and software to broadcast and receive messages either using the Wi-Fi Direct Standard (see Wi-Fi Direct specification published in Oct. 2010) and/or the IEEE 802.11 wireless standard (see IEEE 802.11-2007, published March 8, 2007; IEEE 802.11n-2009, published Oct. 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the user device 102 and another device such as an access point, a host computer, a server, a router, a reader device, and the like. The network may include, but is not limited to: the Internet, a private network, a virtual private network, a wireless wide area network, a local area network, a metropolitan area network, a telephone network, and so forth.

The display 114 may include, but is not limited to, a liquid crystal display, a light-emitted diode display, or an E-Ink™ display as made by E Ink Corp. of Cambridge, Mass. The display 114 may be used to show content to a user in the form of text, images, or video. In certain instances, the display 114 may also operate as a touch screen display that may enable the user to initiate commands or operations by touching the screen using certain finger or hand gestures.

According to one or more embodiments, the user device 102 may be in communication, via one or more networks 116, with one or more service provider server(s) 118. As used herein, unless otherwise specified, the term “server” may refer to any computing device having a networked connectivity and configured to provide one or more dedicated services to clients, such as a user device 102. The services may include storage of data or any kind of data processing. One example of the server may include a web server hosting one or more web pages. Some examples of web pages may include social networking web pages and/or social media websites. Another example of a server may be a cloud server that hosts web services for one or more computer devices.

As such, the service provider server(s) 118 may include one or more processors 120 and a memory 122. As such, the memory 122 may store an operating system 124, a recommendation module 126, a list generation module 128, a search module 130, and a connections module 132. In addition, the service provider server(s) 118 may also include network and I/O interfaces 134, a display 136, and storage 138. Furthermore, in some embodiments, one or more live auction servers may also be in communication with the network 116. To this end, the one or more live auction servers may store auction data associated with one or more live wholesale auctions and retail auctions. In certain implementations, the auctions may be timed virtual online auctions in which bidders may bid for vehicle online for a determined period of time. In some instances, after the determined period of time has elapsed, the vehicle may be run through a physical lane (e.g., auction lane at a physical auction location). Alternatively, the auctions may be simulcast from physical auction locations and/or the entire auction may be simulcast such that all participants may be located in any geographical location. Thus, the user devices 102, service provider server(s) 118, and/or any other third party devices may be able to access vehicle information, associated with one or more vehicles, from the live auction server(s).

According to one or more embodiments, the vehicle auction application 110 may enable users to manage, search, display, and/or otherwise facilitate transactions associated with one or more vehicles being auctioned at one or more vehicle auctions. In some instances, the vehicle auction application 110 may provide an interactive user interface to a user, which may represent a marketplace for the user to interact with vehicles that are being auctioned, or that are soon to be auctioned, at one or more auctions. As such, the auction application 110 may communicate various user selections and preferences to the service provider server(s) 118. As a result, the service provider server(s) 118 may process the user selections and make various determinations based on those selections (e.g., via one or more modules such as the recommendation module 126, list generation module 128, search module 130, and the connections module 132. Alternatively, the auction application 110 may be configured to provide (e.g., via the one or more processors) the processing capability to perform certain actions based on user interaction with the user interface. It should be noted that the components depicted in the user devices and service provider servers 118 in FIG. 1, and their respective functionalities, may be distributed across the user devices 102, service provider servers 118, and/or any other third-party devices according to any combination. For example, certain module included in the service provider servers 118 may also be included in the auction application. In addition, the auction application 110 may be include din the service provider servers 118,

In certain implementations, the auction application 110 may be configured to facilitate one or more vehicle searches at one or more auctions. For example, the auction application 110 may provide an interface for the user to enter search parameters for vehicles, including, but not limited to make, model, year, mileage, color, condition, type, options, trim packages, market conditions, price, financing options, and/or the like. To this end, the auction application 110 may be configured to provide the search parameters to the search module 130 in the service provider server(s) 118. The search module 130 may then be configured to perform a search, based at least in part on the search parameters, for one or more vehicles associated with the vehicle auctions.

In addition to performing searches, the auction application 110 and/or the search module 130 may be configured to store saved searches and/or search histories associated with the user. For example, the user may input search parameters related to vehicle model and color. To this end, the auction application 110 may be configured to store the search parameters and/or any search results (e.g., on the user device 102 and/or on the service provider server(s) 118). Furthermore, the auction application 110 may enable the user to retrieve the saved search parameters and/or search results at a later point in time to review the search results and/or to update the search results. In addition, the auction application 110 may be configured to display one or more comparisons between respective search results of saved searches and/or other types of searches. Additionally, the auction application 110 and/or the search module 130 may be configured to record or store a search history associated with the user. The search history may provide the user access to one or more recent searches initiated by the user (e.g., the search history may list the 10 most recent searches performed by the user). In some implementations, the auction application 110 may provide the user (e.g., via the user interface) the ability to store one or more searches in the history as saved searches.

According to some embodiments, in addition to providing search capabilities, the auction application 110 may also be configured to provide vehicle browsing functionality. For example, the auction application 110 may enable the user to apply successive filters based on various parameters (e.g., similar to the search parameters listed above). The filters may successively narrow and/or further categorize one or more subsets of vehicles at auction. In some implementations, as the filters are applied, a graphical representation of the successively narrowed subset of vehicles may be displayed to the user. For example, a histogram of various attributes (e.g., vehicle type, make, model, conditions score, retail price, wholesale price, purchase price, market demand, market supply, etc.) associated with one or more vehicles that correspond to a particular set of filters may be displayed. As such, the display of the histogram may change according to the particular filters that the user may choose to apply.

In certain implementations, the auction application 110 may provide the user access (e.g., via the user interface) to purchase histories. Thus, the user may be able to view one or more vehicles associated with the user's past purchases from the auctions. In addition, the auction application 110 may also provide the user access purchases histories associated with certain vehicles, markets, and/or geographical locations. Furthermore, in some implementations, the auction application 110 may also be configured to indicate an amount of progress the user has achieved toward receipt/ownership of a purchased vehicles. For example, the auction application 110 may display a progression bar, or any other type of status indicator, to indicate user progress in obtaining receipt of purchased vehicles.

According to one or more embodiments, the auction application may also be configured to generate one or more vehicle lists (e.g., via the list generation module 128 in the service provider server(s) 118) based on user input. For example, the user may wish to categorize or record different prospective vehicles according to different groups and/or criteria. For instance, a particular dealer and/or dealer employee may wish to categorize a list of potential vehicles to purchase by one or dealer teams. Another list may be associated with a personal wish list of potential vehicles to purchase. To this end, the auction application 110 may be configured to associate certain vehicle lists with certain searches and/or save searches performed by the user. Furthermore, the user may be able to add vehicles to vehicle lists in a variety of ways. For instance, the user may be able to add the vehicles from browsing a set or subset of vehicles, search results, one or more displays of auctioned vehicles, other user's vehicle lists, recommended vehicles, and/or the like.

The auction application 110 may also be configured to provide the user with multiple views associated with multiple auction lanes in multiple auctions. For example, a user interface associated with the auction application 110 may display one or more rows of vehicles. Each row may correspond to an auction “lane” in which vehicles are being auctioned. To this end, the auction lanes may be associated with the same or different auctions, and may be located in diverse geographical locations. Furthermore, each row of displayed vehicles may be ordered according to the order that they will be auctioned. To this end, the user interface of the auction application 110 may be configured to indicate which vehicle is being auctioned, the type of auction (e.g., timed online auction, buy-now sale, simulcast auction, simulcast anywhere/everywhere auction, etc.), the current highest bid for the vehicle, the market price for the vehicle, a rating of the vehicle, and/or any other auction or vehicle related data. In some instances, auction lanes may be simulcast, and/or streamed live from the physical locations of the auction lanes.

According to one or more embodiments, the auction application 110 may be configured to provide social connections (e.g., via the connections module 132) between users associated with the auction application 110. For example, users of the auction application 110 may be able to connect with other users and share various information such as contact information, workbooks, vehicle lists, purchase histories, and/or the like. In addition, the connections module 132 may facilitate user interaction between users such as facilitating interchange of messages, posting messages or thoughts for other users to see, leaving comments, and other social media features appreciated by those in the art. In certain embodiments, the connections module 132 may facilitate sharing a user's vehicle lists with other users and may provide notifications to the other users when the user adds and/or removes vehicles from the vehicle lists. It should also be noted that users of the auction application may be vehicle sellers, other vehicle buyers, auction personnel (e.g., an auction desk clerk) or any other type of user. To this end, the connections module 132 may be configured to facilitate connections between any the various types of users. For example, during an auction, users who are virtual bidders may be able to interact (e.g., via the connections module 132) with auction personnel directly, such as the auctioneer and/or desk clerk.

According to one or more embodiments, the auction application 110 may be configured to provide one or more vehicle recommendations to the user. Such recommendations may be based at least in part on purchase histories, search histories, saved searches, vehicle lists, and/or the like that may be associated with the user. For example, the user may have stored a vehicle list to keep track of one or more vehicles for potential purchase. To this end, the recommendation module 126 may be configured to access this vehicle list and determine certain vehicle parameters that one or more vehicles from the vehicle list share. As such, the recommendation module 126 may access auction data and determine one or more auctioned vehicles that are associated with the same or similar vehicle parameters. After determining the auctioned vehicles, the recommendation module 126 may be configured to provide the auctioned vehicles to the user.

In some embodiments, the auction application 110 may be configured to provide rewards and/or a point system to the user. To this end, the rewards module may keep track of vehicle purchases associated with the user. The rewards module may be configured to alert the user when a certain point thresholds have been met and/or when the user is nearing a particular reward. In addition, the user interface associated with the auction application may display certain indicators associated with certain vehicles; such indicators may indicate a certain number of points and/or the type of rewards that may be associated with the purchase of the vehicles. In addition to rewards and/or points, the auction application 110 may also be configured to enable the user to set specific goals (e.g., purchasing 10 vehicles of a particular model) for the user or team to meet. The auction application 110 may also enable to the user to share such goals with other users. In some implementations, the one or more rewards programs may be provided a third party system or device in communication with the auction application 110 and/or the service provider server(s) 118. It should be noted that in certain implementations, the auction application 110 may enable different levels of users. For instance a super-user may have enhanced capabilities (e.g., more permissions, security, insight, etc.) compared to sub-users of the super-user. For instance a super-user associated with a dealer group may be able to set one or more group-wide targets or goals for the group to achieve. As such, the auction application 110 may be able to track/monitor points on various levels, such as an individual level, a group level, a global level, and/or any other level or type of category.

The auction application 110 may also be configured to notify or alert the user to certain events that may be relevant to the user. For example, the auction application 110 may notify the user (e.g., via email, within the auction application, SMS text, etc.) when a particular vehicle is about to be auctioned. Similarly, the auction application may notify the user when an auction on a particular vehicle is about to end. Other notifications may include the success or failure of a user bid for a particular vehicle and/or the winning bid amount for the particular vehicle. It should be understood any type of information may be provided to the user as alerts or notifications. Furthermore, the user may be able to configure the notification to occur at certain specified periods of time (e.g., instantly as they are received, once a day, once a week, etc.).

In certain embodiments, with respect to the views of the auction lanes provided by the user interface of the auction application 110, multiple “baseball card” or thumbnail views may be displayed for respective vehicles being auctioned in the auction lanes. These card views may display a summary of certain vehicle information associated with the respective vehicles. Once a card has been selected, the card and/or view of the respective vehicle may be expanded to include more detailed information associated with the respective vehicle and/or a larger image/photographic display of the vehicle. In some instances, the card views and/or the expanded views may display information that includes, but is not limited to, vehicle model, make, year, color, trim, options, mileage, market day supply, market trends, market price, market ratings, condition, desirability scores, market supply and demand metrics, and/or any other type of vehicle and/or market information. In other instances, the expanded view may include information from third-party services, such as Carfax or vehicle history reports, condition reports, and/or other services. In addition, the user interface may also be configured to display certain workbooks/vehicle lists associated with the user as a series of card views for respective vehicles. To this end, the card views may be arranged in order of time-sensitivity in the sense that the card view associated with the vehicle that is nearest to having its auction period end may be displayed first. Subsequent views may be displayed based on decreasing time sensitivity. Of course, other orders of arranging the card views for the workbooks/vehicle lists are also contemplated within the present disclosure.

In addition to card views, the user interface of the auction application 110 may also be configured to provide a calendar view of sales and/or auctioned vehicles. For example, in a calendar view, the user may be provided with a display of the timing and schedule of certain auctions for certain vehicles. The display may identify where sales and auctions overlap or may be in conflict with each other. Such information may facilitate more efficient proxy bidding timing on the part of the user. In addition, the views may facilitate prioritizing auctions and/or participating in multiple auctions at once (e.g., multiple virtual online auctions, and or simulcast auctions).

Various other features may also be monitored and or provided by the auction application 110. For instance, the auction application may be configured to monitor one or more credit accounts that may be associated with the user and provide indications of the amount of funds left in the accounts and/or proximity to respective credit limits. In some embodiments, such monitoring may take into account any outstanding bids that may currently be associated with the user and/or divestiture of any auctioned vehicles. To this end, the auction application may be configured to receive real-time data from dealer computers or database management systems associated with dealer computers regarding retail sales that may affect respective credit limits of the credit accounts. In addition, the auction application 110 may provide notifications to the user indicating low funds or available funds. The auction application 110 may also enable the user to choose from which accounts to purchase and/or bid on certain vehicles. Another feature may be that the user interface may indicate real-time data, such as market conditions, associated with a vehicle that is being auctioned. For example, as bids are received for a certain vehicle, a graph indicating the current bid amount, market demand, and other information may be updated.

In addition, for any vehicle that is being viewed within the auction application 110, the user interface may display certain metrics of popularity for that vehicle. For example, the user interface may display how many times the vehicle has appeared in search results over a specified period of time. Furthermore, the user interface may also display how many users and/or the particular users that have added the vehicle to a vehicle list and/or workbook.

Furthermore, it will be appreciated that the user interface for the auction application may be customizable based on user preference. For example, certain tabs, columns, and/or selection indicators may be arranged according to user preference. Graphical components, such as icons, text fields, buttons, forms, windows, and/or the like may also be added, removed, and/or rearranged according to user preference. Additionally, the types and/or categories of vehicles displayed by the auction application may also be arranged according to user preference. In some instances the view or display of the vehicles may also include the option of a 360-degree view of a vehicle's exterior and interior. To this end, the view may also provide for zoom in and zoom out capabilities to identify certain physical characteristics of the vehicle, such as any issues with the vehicle.

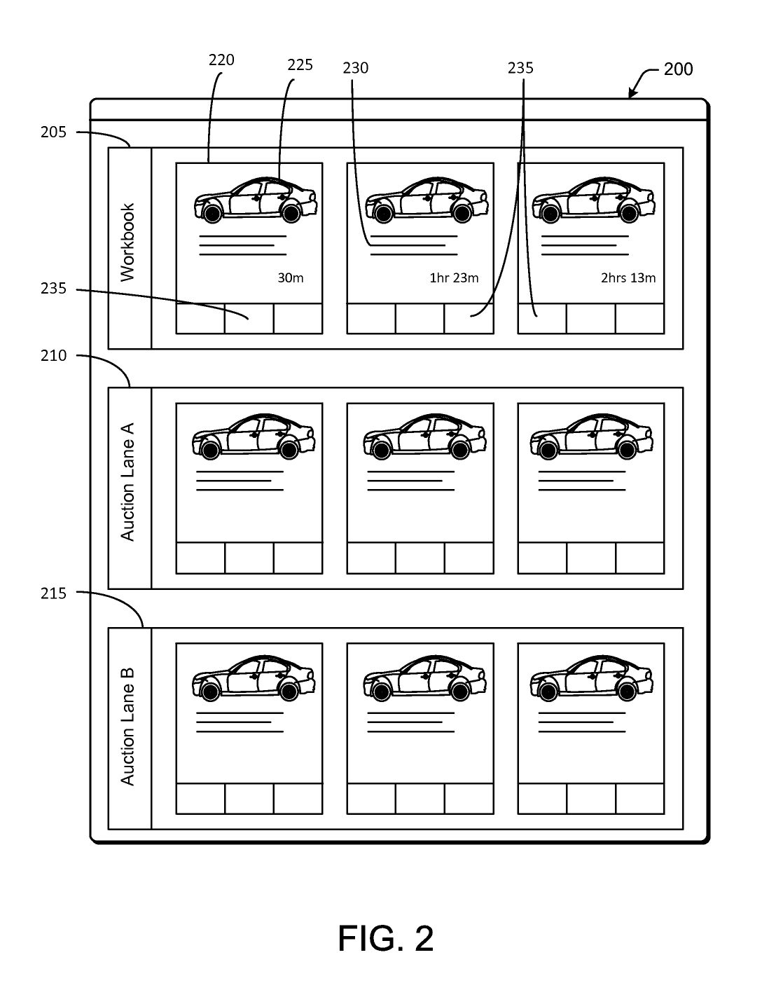

Referring now to FIG. 2, a user interface 200 for managing auction data is illustrated in accordance with one or more example embodiments. In certain embodiments, the user interface 200 may facilitate user interaction with various vehicles that may be auctioned at one or more auctions. The user interface 200 may include graphical representations of a workbook view 205, and one or more auction lanes, such as auction lane A 210 and auction lane B 215. Each of the workbook view 205 and auction lane views 210/215 may include and/or otherwise display card views 220 of their respective vehicles. For example, the workbook view 205 may include respective card views 220 of one or more workbook vehicles. In some implementations, the workbook vehicles may be vehicles that a user has previously selected and/or designated as workbook vehicles. In other implementations, the workbook vehicles may also include vehicles that the user has previously viewed (e.g., a viewing history). As another example, the auction lane views 210/215 may include card views 220 of vehicles being auctioned and/or vehicles schedule to be auctioned in respective auction lanes. The respective auction lanes may be both physical auction lanes and/or electronic/online auction lanes. Furthermore, the respective auction lanes may be at the same and/or in different locations.

Each of the card views 220 may also include and/or display a vehicle image 225 of the corresponding vehicle, as well as vehicle information 230 associated with the corresponding vehicle. Vehicle information may include any type of information related to the corresponding vehicle and/or to an associated vehicle auction. For instance, vehicle information may include a make, model, trim, price, rating, mileage, and/or the like. The vehicle information may also include condition reports, condition scores, condition ratings, vehicle condition history, and/or the like (e.g., Manheim AutoGrade and VehicleHistory). Additionally, the vehicle information may also include an auction time, a remaining auction time, auction identifier, auction lane identifier, and/or the like.

According to one or more embodiments, the card views 220 of the workbook view 205 may be arranged and/or ordered according to a time-sensitivity associated with corresponding workbook vehicles. For instance, the card views 220 may be ordered according to respective remaining auction times associated with the workbook vehicles. In some implementations, the card view 220 may be displayed from left to right in order of increasing remaining auction times. As a result, the user interface 200 may be able to notify a user (e.g., via the display of the card views 220) of his/her workbook vehicles that have the least amount of remaining auction times. It will be appreciated, however, that the card views 220 may be arranged according to any other type of ordering, such as by auction start times, auction locations, and/or the like.

With respect to the auction lanes 210/215, the card views 220 of the auction vehicles may be arranged according to the order in which the auction vehicles are to be auctioned. For instance, in certain implementations, card views 220 displayed in the auction views 210/215 may be arranged from left to right in order of which they are to be auctioned. Furthermore, the card views 220 may also represent vehicles being auctioned at different auction lanes in the same auction, at different auction lanes in different auctions, in online form only, and/or any combination thereof. Thus, the card views 220 for a particular auction lane 210/215 may be configured to represent vehicles being auctioned at different geographical locations. In some embodiments, the card views 220 displayed an auction lane 210/215 may represent one or more vehicles selected from a user's workbook view 205. Such a selection may be based at least in part on user preference data or user priority data, auction times associated with selected vehicles, auction lane order, vehicle and/or auction locations, and/or the like.

Additionally, the card views 220 may also include one or more selectable components 235 that may be configured, upon selection, to initiate various actions related to the corresponding vehicles. For instance, selecting a selectable component 235 of a particular card view 220 may initiate a bid for a vehicle associated with the particular card view 220. Other types of actions may include, but are not limited to, purchasing the vehicle associated with the particular card view 220, initiating a proxy bid for the vehicle, contacting an owner or seller of the vehicle, and/or any other action related to the vehicle and the associated auction lane.

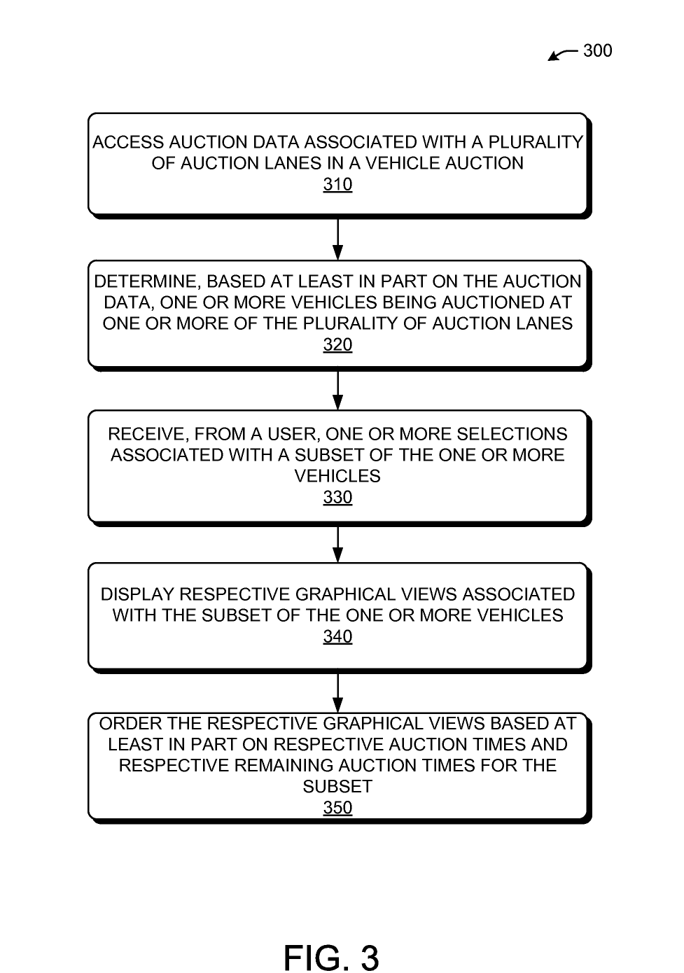

Turning now to FIG. 3, a flow diagram of a method 300 for managing auction data is provided in accordance with one or more example embodiments. The method may begin in block 310, in which a service provider server 118 may be configure to access auction data associated with a plurality of auction lanes in a vehicle auction. In block 320, the service provider server 118 may determine, based at least in part on the auction data, one or more vehicles being auctioned at one or more of the plurality of auction lanes.

In block 330, the service provider server 118 may receive, from a user, one or more selections associated with a subset of the one or more vehicles. In block 340, the service provider server 118 may display respective graphical views associated with the subset of the one or more vehicles. In block 350, the service provider server 118 may order the respective graphical views based at least in part on respective auction times and respective remaining auction times for the subset of the one or more vehicles.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
accessing, by a server comprising one or more processors, auction data associated with a plurality of auction lanes in a vehicle auction;
determining, based at least in part on the auction data, one or more vehicles being auctioned at one or more of the plurality of auction lanes;
receiving, from a user device, one or more selections associated with a subset of the one or more vehicles;
displaying, by the server, respective graphical views associated with the subset of the one or more vehicles; and
ordering the respective graphical views based at least in part on respective auction times and respective remaining auction times for the subset of the one or more vehicles.

2. The method of claim 1, further comprising:
receiving one or more vehicle search parameters;
determining, based at least in part on the one or more vehicle search parameters and the auction data, one or more vehicles; and
storing the one or more vehicle search parameters for subsequent viewing.

3. The method of claim 2, wherein storing the one or more vehicle search parameters comprises storing the one or more vehicle search parameters as a saved search associated with the user.

4. The method of claim 2, further comprising submitting a bid, on behalf of the user, for at least one of the one or more vehicles.

5. The method of claim 1, further comprising:
generating a vehicle workbook associated with the user, wherein the workbook comprises one or more vehicle lists listing vehicles-of-interest being from the vehicle auction.

6. The method of claim 5, further comprising:
determining, from a saved search, a vehicle associated with a result of the saved search; and
adding the vehicle to the vehicle workbook.

7. The method of claim 5, further comprising:
sharing the one or more vehicle lists with another user.

8. The method of claim 1, further comprising receiving one or more notifications associated with a vehicle that is added or removed from a vehicle list of another user.

9. The method of claim 1, wherein the plurality of auctions are associated with a plurality of locations.

10. The method of claim 1, further comprising transmitting, by the server, a real-time video stream of at least one on the auction lanes.

11. The method of claim 1, further comprising receiving, by the server, an expanded view associated with at least one of the respective graphical views, the expanded view configured to display at least one of vehicle make, model, year, trim, options, mileage, market day supply, market trends, estimated days on lot, or third-part vehicle condition data.

12. A device, comprising:
at least one processor; and
at least one memory storing computer-readable instructions that when executed by the at least one processor, cause the at least one processor to:
access auction data associated with a plurality of auction lanes in a vehicle auction;
determine, based at least in part on the auction data, one or more vehicles being auctioned at one or more of the plurality of auction lanes;
receive, from a user device, one or more selections associated with a subset of the one or more vehicles;
display respective graphical views associated with the subset of the one or more vehicles; and
order the respective graphical views based at least in part on respective auction times and respective remaining auction times for the subset of the one or more vehicles.

13. The device of claim 12, wherein the at least one memory comprises further instructions that cause the at least one processor to:
receive one or more vehicle search parameters;
determine, based at least in part on the one or more vehicle search parameters and the auction data, one or more vehicles; and
store the one or more vehicle search parameters for subsequent viewing.

14. The device of claim 13, wherein the instructions to store the one or more vehicle search parameters comprise instructions to store the one or more vehicle search parameters as a saved search associated with the user.

15. The device of claim 13, wherein the instructions to store the one or more vehicle search parameters comprise instructions to store the one or more vehicle search parameters in a search history associated with the user.

16. The device of claim 15, further comprising instructions that cause the at least one processor to:
receive a selection of a respective set of vehicle search parameters from the search history; and
store the respective set of vehicle search parameters as a saved search.

17. The device of claim 12, further comprising instructions that cause the at least one processor to generate a vehicle workbook associated with the user, wherein the workbook comprises one or more vehicle lists listing vehicles-of-interest being from the vehicle auction.

18. The device of claim 17, further comprising instructions that cause the at least one processor to:
determine, from a saved search, a vehicle associated with a result of the saved search; and
add the vehicle to the vehicle workbook.

19. The device of claim 12, further comprising instructions that cause the at least one processor to share the one or more vehicle lists with another user.

20. The device of claim 12, further comprising instructions that cause the at least one processor to receive an expanded view associated with at least one of the respective graphical views, the expanded view configured to display at least one of vehicle make, model, year, trim, options, mileage, market day supply, market trends, estimated days on lot, or third-part vehicle condition data.

21. A non-transitory computer-readable storing instructions, that when executed by one or more processors, cause the at least one or more processors to:
access auction data associated with a plurality of auction lanes in a vehicle auction;
determine, based at least in part on the auction data, one or more vehicles being auctioned at one or more of the plurality of auction lanes;
receive, from a user device, one or more selections associated with a subset of the one or more vehicles;
display respective graphical views associated with the subset of the one or more vehicles; and
order the respective graphical views based at least in part on respective auction times and respective remaining auction times for the subset of the one or more vehicles.

22. The computer-readable medium of claim 21, further comprising instructions that cause the one or more processors to:
receive one or more vehicle search parameters;
determine, based at least in part on the one or more vehicle search parameters and the auction data, one or more vehicles; and
store the one or more vehicle search parameters for subsequent viewing.

23. The computer-readable medium of claim 21, wherein the instructions to store the one or more vehicle search parameters comprise instructions to store the one or more vehicle search parameters as a saved search associated with the user.

24. The computer-readable medium of claim 21, wherein the instructions to store the one or more vehicle search parameters comprise instructions to store the one or more vehicle search parameters in a search history associated with the user.

25. The computer-readable medium of claim 24 further comprising instructions that cause the at least one processor to:
receive a selection of a respective set of vehicle search parameters from the search history; and
store the respective set of vehicle search parameters as a saved search

26. The computer-readable medium of claim 21, wherein the plurality of auctions are associated with a plurality of locations.

27. The computer-readable medium of claim 21, further comprising instructions that cause the at least one processor to generate a vehicle workbook associated with the user, wherein the workbook comprises one or more vehicle lists listing vehicles-of-interest being from the vehicle auction.

28. The computer-readable medium of claim 21, further comprising instructions that cause the at least one processor to:
determine, from a saved search, a vehicle associated with a result of the saved search; and
add the vehicle to the vehicle workbook.

29. The computer-readable medium of claim 21, further comprising instructions that cause the at least one processor to share the one or more vehicle lists with another user.

30. The computer-readable medium of claim 21, further comprising instructions that cause the at least one processor to receive one or more notifications associated with a vehicle that is added or removed from a vehicle list of another user.

31. The computer-readable medium of claim 21, further comprising instructions that cause the at least one processor to receive an expanded view associated with at least one of the respective graphical views, the expanded view configured to display at least one of vehicle make, model, year, trim, options, mileage, market day supply, market trends, estimated days on lot, or third-part vehicle condition data.
